(19) United States
(12) Patent Application Publication
(10) Pub. No.: US 2024/0302575 A1
(43) Pub. Date: Sep. 12, 2024

(54) COMPOSITE HIGH SCRATCH-RESISTANT OPTICAL LENS DEVICE AND MANUFACTURING METHOD THEREOF

(71) Applicant: FORESIGHT OPTICAL LTD., Tainan (TW)

(72) Inventors: YUE-CHANG TSAI, Tainan (TW); TIEN-SHU WU, Tainan (TW); YEN-TING WU, Tainan (TW)

(21) Appl. No.: 18/212,107

(22) Filed: Jun. 20, 2023

(30) Foreign Application Priority Data
Mar. 6, 2023 (TW) 112108144

(51) Int. Cl. G02B 1/14; B29D 11/00

(52) U.S. Cl. CPC G02B 1/14; B29D 11/0073; B29K 2995/002; B29K 2995/003; B29K 2995/0034; B29K 2995/007; B29K 2995/0097

(57) ABSTRACT

A manufacturing method for optical lens devices includes: providing a first scratch-resistant layer on a first outer surface of a first protective layer having a structural reinforcement function to form a first reinforced protective layer; providing a second scratch-resistant layer on a second outer surface of a second protective layer having a structural reinforcement function to form a second reinforced protective layer; forming a containing space layer between a first inner surface of the first protective layer and a second inner surface of the second protective layer; providing an intermediate layer in the containing space layer; the first scratch-resistant layer and the first protective layer commonly protecting a first side of the containing space layer while the second scratch-resistant layer and the second protective layer commonly protecting a second side of the containing space layer.

### BACKGROUND OF THE INVENTION

### 1. Field of the Invention

The present invention relates to a composite high scratch-resistant optical lens device and manufacturing method thereof. Particularly, the present invention relates to a composite double-sided high scratch-resistant optical lens device and manufacturing method thereof.

### 2. Description of the Related Art

Taiwanese Patent Publication No. 1752471, entitled “Scratch-resistant optical lens device with laminated glass/plastic composites,” discloses a laminated glass/plastic-composite scratch-resistant optical lens device, including a functional layer, a first scratch-resistant protective layer and a second protective layer.

As described above, the functional layer has a first front side surface and a second rear side surface, with forming the first scratch-resistant protective layer on the first front side surface to provide a scratch-resistant protection function or property on the first front side surface of the functional layer.

Furthermore, the second protective layer, corresponding to the first scratch-resistant protective layer, is formed on the second rear side surface, corresponding to the first front side surface, to provide a protection function or property on the second rear side surface of the functional layer, with the scratch-resistant protection function of the scratch-resistant protective layer having a degree greater than or equal to that of the second protective layer.

Another Taiwanese Patent Application Publication No. 201502600, entitled “Photochromic composite lens,” discloses a photochromic composite lens device, comprising a front side lens, a rear side lens, an intermediate layer and a functional coating layer. Provided between the front side lens and the rear side lens is a supporting structure to thereby form the intermediate layer.

As described above, the front side lens is provided on an outer side while the rear side lens is provided on an inner side. The intermediate layer is made of a photochromic dye material and the supporting structure defines a uniform thickness space such that the photochromic dye material filled in the uniform thickness space provides a uniform thickness layer.

Furthermore, the front side lens has an outer side surface on which to selectively combine with a first functional coating layer while the rear side lens has an inner side surface on which to selectively combine with a second functional coating layer.

Another U.S. Pat. No. 5,116,684, entitled “Composite ophthalmic lens,” corresponding to Taiwanese Patent Publication No. 215476, discloses a composite ophthalmic lens device, comprising an inorganic glass layer, a rigid, organic plastic layer and a silicon gasket, with the rigid, organic plastic layer selected from an optically clear, epoxy polymer material.

As described above, the optically clear, epoxy polymer material is formed from an aliphatic and/or aromatic epoxide monomer, a curing agent, a source of active hydroxyl group and an accelerator, and has a predetermined refractive index. The ratio of curing agent to epoxy, by equivalent weights, is between 2:5 to 5:4, the ratio of curing agent to source of active hydroxyl group, by equivalent weights, is between 2:1 to 6:1, and the amount of accelerator is at least 0.01%, but no over 1.0%, of the mixture.

FIG. 1 shows a schematic side view of a composite ophthalmic lens device described in U.S. Pat. No. 5,116,684 in accordance with the prior art. Turning now to FIG. 1, the composite ophthalmic lens device has a structure comprised of the inorganic glass layer, the rigid, organic plastic layer and the silicon gasket to cast a casting mix such that no functional optical layer is formed among the inorganic glass layer, the rigid, organic plastic layer and the silicon gasket.

Another Taiwanese Patent Publication No. 346442, entitled “Composite plastic optical quality lenses and method for making the same,” corresponding to U.S. Pat. No. 5,702,819, discloses a first composite plastic lens device, comprising a plastic lens preform portion and a cured plastic attached portion.

As described above, the plastic lens preform portion is molded from an optical quality material, with the cured plastic attached portion bonded to the plastic lens preform portion. In comparison with the optical quality material of plastic lens preform portion, a resin composition of the cured plastic attached portion has a higher scratch resistance, a lower chromatic aberration, and/or a high ease of edging than those of the plastic lens preform portion. The resin composition of the cured plastic attached portion has a refractive index within about 0.05 units of refractive index of the plastic lens preform portion.

Furthermore, Taiwanese Patent Publication No. 346442 also discloses a second composite plastic lens device, comprising a plastic lens preform portion which is made of aromatic polycarbonate polymer and a cured plastic attached portion which is made of resin composition.

As described above, the resin composition of cured plastic attached portion has a first resin portion and a second resin portion, with the first resin portion comprising bisallyl carbonate, with the second resin portion selected from a group consisting of one or more multi-functional acrylates, one or more multi-functional methacrylates and a mixture of one or more multi-functional acrylates and one or more multi-functional methacrylates.

In the second composite plastic lens device, in comparison with the optical quality material of plastic lens preform portion, the resin composition of cured plastic attached portion has a higher scratch resistance, a lower chromatic aberration, and/or a high ease of edging than those of the plastic lens preform portion. The resin composition of the cured plastic attached portion also has a refractive index within about 0.05 units of refractive index of the plastic lens preform portion.

Another Taiwanese Utility-Model Patent Publication No. M263511, entitled “Composite lens structure having a polarization thin film,” discloses a composite lens structure device, comprising an outer side lens, an inner side lens and a polarization thin film.

As described above, the outer side lens is formed from a first preform arc-shaped lens piece, with having an inner edge surface and an inner edge cambered surface, with the inner edge cambered surface defining (R2). The inner side lens is formed from a second preform arc-shaped lens piece, with having an outer edge surface and an outer edge cambered surface, with the outer edge cambered surface defining (R3).

The inner edge cambered surface defining (R2) of outer side lens is identical with the outer edge cambered surface defining (R3) of inner side lens. The polarization thin film is formed from a film body, with having an upper surface and a lower surface. The upper surface is provided with a first adhesive coating layer while the lower surface is provided with a second adhesive coating layer. The polarization thin film is adhered between the inner side lens and the outer side lens to perform a polarization effect of composite lens structure device.

Another U.S. Pat. No. 4,793,703, entitled “Laminated glass lens,” corresponding to Taiwanese Patent Publication No. 215476, discloses a laminated glass/plastic composite device, comprising an inorganic glass layer, an organic plastic layer and an adhesive layer.

FIG. 2 shows a schematic side view of a laminated glass/plastic composite device described in U.S. Pat. No. 4,793,703 in accordance with the prior art. Turning now to FIG. 2, the inorganic glass layer of laminated glass/plastic composite device is formed as a glass front surface layer while the organic plastic layer of laminated glass/plastic composite device is formed as a plastic back surface layer.

As described above, a first structure of the laminated glass/plastic composite device is simply formed from the inorganic glass layer, the organic plastic layer and the adhesive layer, with none of which being provided with a functional thin film, as best shown in FIG. 2.

FIG. 3 shows a schematic side view of another laminated glass/plastic composite device described in U.S. Pat. No. 4,793,703 in accordance with the prior art. Turning now to FIG. 3, the laminated glass/plastic composite device comprises an inorganic glass layer, a first organic plastic layer, a second organic plastic layer, a first adhesive layer and a second adhesive layer.

As described above, a second structure of the laminated glass/plastic composite device is simply formed from the inorganic glass layer, the first organic plastic layer, the second organic plastic layer, the first adhesive layer and the second adhesive layer, with none of which being provided with a functional thin film, as best shown in FIG. 3.

However, there is a need of improving the conventional composite lens devices or structures for providing a composite high scratch-resistant optical lens device and manufacturing method thereof. The above-mentioned patents and patent application publications are incorporated herein by reference for purposes including, but not limited to, indicating the background of the present invention and illustrating the situation of the art.

### SUMMARY OF THE INVENTION

The primary objective of this invention is to provide a composite high scratch-resistant optical lens device and manufacturing method thereof. A first scratch-resistant layer is provided on a first outer surface of a first protective layer having a structural reinforcement function to form a first reinforced protective layer. A second scratch-resistant layer is provided on a second outer surface of a second protective layer having a structural reinforcement function to form a second reinforced protective layer. A containing space layer is formed between a first inner surface of the first protective layer and a second inner surface of the second protective layer. An intermediate layer is provided in the containing space layer, with the first scratch-resistant layer and the first protective layer commonly protecting a first side of the containing space layer, with the second scratch-resistant layer and the second protective layer commonly protecting a second side of the containing space layer. Advantageously, the optical lens device of the present invention is successful in providing two different protection degrees on opposite sides of containing space layer and an enhanced degree of light transmission therebetween.

The composite high scratch-resistant optical lens device in accordance with an aspect of the present invention includes:
a first protective layer having a function of structural reinforcement;
a first scratch-resistant layer having a function of surface-scratch resistant, with providing the first scratch-resistant layer on a first outer surface of the first protective layer for forming a first reinforced (laminated) protective layer thereon;
a second protective layer having a function of structural reinforcement;
a second scratch-resistant layer having a function of surface-scratch resistant, with providing the second scratch-resistant layer on a second outer surface of the second protective layer for forming a second reinforced (laminated) protective layer thereon;
at least one containing space layer formed between a first inner surface of the first protective layer and a second inner surface of the second protective layer; and at least one intermediate layer provided in the containing space layer for protection;
wherein the first scratch-resistant layer and the first protective layer are provided to commonly protect a first side of the containing space layer while the second scratch-resistant layer and the second protective layer are provided to commonly protect a second side of the containing space layer.

In a separate aspect of the present invention, the intermediate layer is selected from an anti-reflection layer, a polarization thin-film layer, a polarization microstructure layer, a photochromic layer, an anti-blue layer, an anti-blue UV layer, an anti-infrared layer or combinations thereof.

In a further separate aspect of the present invention, the intermediate layer is integrated with the first inner surface of the first protective layer to form a single layer.

In yet a further separate aspect of the present invention, the intermediate layer is integrated with the second inner surface of the second protective layer to form a single layer.

In yet a further separate aspect of the present invention, the intermediate layer is integrated with the first inner surface of the first protective layer and the second inner surface of the second protective layer to form a single layer.

In yet a further separate aspect of the present invention, the first protective layer has a first degree of hardness greater than a second degree of harness of the second protective layer.

In yet a further separate aspect of the present invention, the first protective layer has a first thickness greater than a second thickness of the second protective layer.

The manufacturing method for composite high scratch-resistant optical lens devices in accordance with another aspect of the present invention includes:
providing a first scratch-resistant layer on a first outer surface of a first protective layer having a function of structural reinforcement to form a first reinforced (laminated) protective layer thereon;
providing a second scratch-resistant layer on a second outer surface of a second protective layer having a function of structural reinforcement to form a second reinforced (laminated) protective layer thereon;
forming a containing space layer between a first inner surface of the first protective layer and a second inner surface of the second protective layer;
providing an intermediate layer in the containing space layer for protection; and
the first scratch-resistant layer and the first protective layer commonly protecting a first side of the containing space layer while the second scratch-resistant layer and the second protective layer commonly protecting a second side of the containing space layer.

In a separate aspect of the present invention, the intermediate layer is selected from an anti-reflection layer, a polarization thin-film layer, a polarization microstructure layer, a photochromic layer, an anti-blue layer, an anti-blue UV layer, an anti-infrared layer or combinations thereof.

In a further separate aspect of the present invention, the intermediate layer is integrated with the first inner surface of the first protective layer by using similar optical materials therebetween to form a single layer.

In yet a further separate aspect of the present invention, the intermediate layer is integrated with the second inner surface of the second protective layer by using similar optical materials therebetween to form a single layer.

In yet a further separate aspect of the present invention, the intermediate layer is integrated with the first inner surface of the first protective layer and the second inner surface of the second protective layer by using similar optical materials therebetween to form a single layer.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic side view of a composite ophthalmic lens device described in U.S. Pat. No. 5,116,684 in accordance with the prior art.

FIG. 2 is a schematic side view of a laminated glass/plastic composite device described in U.S. Pat. No. 4,793,703 in accordance with the prior art.

FIG. 3 is a schematic side view of another laminated glass/plastic composite device described in U.S. Pat. No. 4,793,703 in accordance with the prior art.

FIG. 4 is a schematic side view of a composite high scratch-resistant optical lens device in accordance with a first preferred embodiment of the present invention.

FIG. 5 is a flow chart of a manufacturing method of composite high scratch-resistant optical lens device in accordance with a preferred embodiment of the present invention.

FIG. 6 is a schematic side view of a composite high scratch-resistant optical lens device in accordance with a second preferred embodiment of the present invention.

FIG. 7 is a schematic side view of a composite high scratch-resistant optical lens device in accordance with a third preferred embodiment of the present invention.

FIG. 8 is a schematic side view of a composite high scratch-resistant optical lens device in accordance with a fourth preferred embodiment of the present invention.

FIG. 9 is a schematic side view of a composite high scratch-resistant optical lens device in accordance with a fifth preferred embodiment of the present invention.

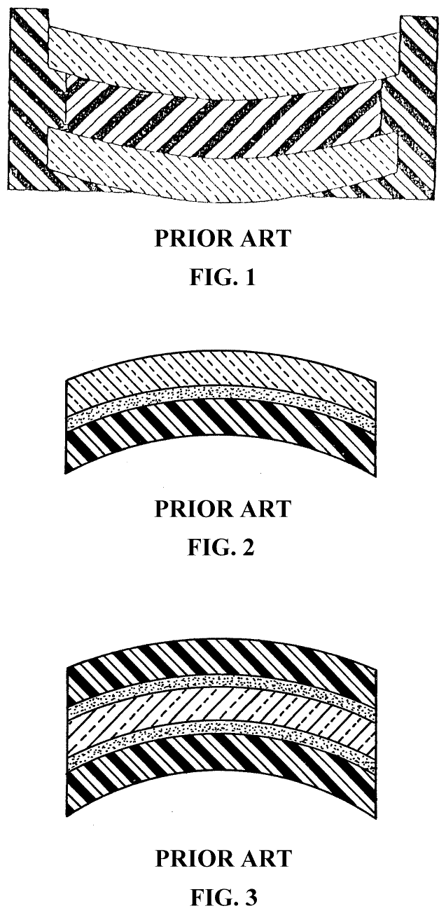

### DETAILED DESCRIPTION OF THE INVENTION

It is noted that a composite high scratch-resistant optical lens device and manufacturing method thereof in accordance with the preferred embodiment of the present invention can be applicable to various glasses (e.g., ophthalmic glasses), various sunglasses, various smart glasses, various sport glasses (e.g., motorcycle-riding glasses), various goggles, various 3D glasses devices, various VR wearable glasses devices, various AR wearable glasses devices or other optical devices, which are not limitative of the present invention.

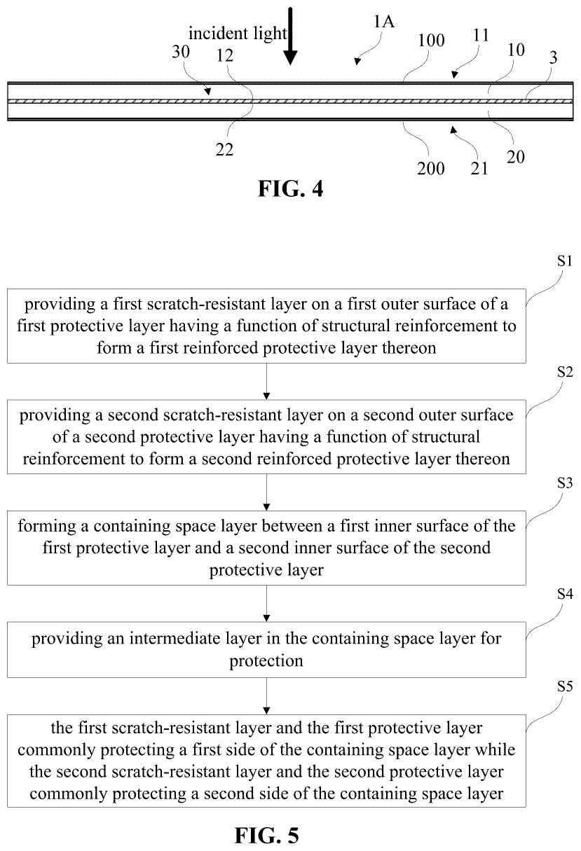

FIG. 4 shows a schematic side view of a composite high scratch-resistant optical lens device in accordance with a first preferred embodiment of the present invention. Referring now to FIG. 4, the composite high scratch-resistant optical lens device in accordance with the first preferred embodiment of the present invention includes a first protective layer 10, a second protective layer 20 and at least one intermediate layer 3 which are combined to form a composite double-sided high scratch-resistant optical lens device 1A.

With continued reference to FIG. 4, by way of example, the first protective layer 10 has a first outer surface 11 and a first inner surface 12, with the first protective layer 10 having a first uniform thickness about 0.1 mm to 5.0 mm, a first hardness, a first refractive index and a first color (dye color material) and is selected from a glass protective layer, a plastic protective layer, a PC (polycarbonate) protective layer, a PMMA (poly(methyl methacrylate)) protective layer, a nylon protective layer a TAC (tri-acetyl cellulose) protective layer, a PET (polyethylene terphthalates) protective layer, a PP (polypropylene) protective layer or made of similar materials thereof.

Still referring to FIG. 4, by way of example, the second protective layer 20 has a second outer surface 21 and a second inner surface 22, with the second protective layer 20 having a second uniform thickness about 0.1 mm to 5.0 mm, a second hardness, a second refractive index and a second color (dye color material) and is selected from a glass protective layer, a plastic protective layer, a PC protective layer, a PMMA protective layer, a nylon protective layer, a TAC protective layer, a PET protective layer, a PP protective layer or made of similar materials thereof.

Still referring to FIG. 4, by way of example, the thickness (or hardness) of first protective layer 10 may be greater or smaller than that of second protective layer 20 to minimize a total thickness or identical with that of second protective layer 20. In a preferred embodiment, the refractive index of first protective layer 10 may be greater or smaller than that of second protective layer 20 or identical with that of second protective layer 20.

Still referring to FIG. 4, by way of example, the intermediate layer 3 is selected from an anti-reflection layer, a polarization thin-film layer, a polarization microstructure layer, a photochromic layer, an anti-blue layer, an anti-blue UV layer, an anti-infrared layer or combinations thereof or a pattern thereof, with sandwiching the intermediate layer 3 between the first protective layer 10 and the second protective layer 20 to thereby strengthen an entire structure.

FIG. 5 shows a flow chart of a manufacturing method of composite high scratch-resistant optical lens device in accordance with a preferred embodiment of the present invention, corresponding to the device as best shown in FIG. 4. Turning now to FIGS. 4 and 5, by way of example, the manufacturing method of composite high scratch-resistant optical lens device has a series of procedure (steps S1, S2, S3, S4 and S5) which may be modified according to needs.

Referring now to FIGS. 4 and 5, by way of example, the manufacturing method of composite high scratch-resistant optical lens device of the present invention includes the step S1: providing at least one first scratch-resistant layer 100 on the first outer surface 11 of first protective layer 10 having a function of structural reinforcement to form a first reinforced (laminated) protective layer thereon by means of coating, spraying, adhering or other suitable manners, with similar or dissimilar materials to those of the first protective layer 10.

Still referring to FIGS. 4 and 5, by way of example, the first scratch-resistant layer 100 is formed from a single layer or multiple layers, with the first scratch-resistant layer 100 having a first predetermined thickness (thinner than that of first protective layer 10) about 0.1 mm to 5.0 mm and a first predetermined hardness (greater than that of first protective layer 10) to reinforce a degree of strength of the first protective layer 10 and to thereby minimize a thickness thereof in design, with a first minimized thickness of the first scratch-resistant layer 100 providing a degree of optical property to comply with international standards.

Still referring to FIGS. 4 and 5, by way of example, the manufacturing method of composite high scratch-resistant optical lens device of the present invention further includes the step S2: providing at least one second scratch-resistant layer 200 on the second outer surface 21 of second protective layer 20 having a function of structural reinforcement to form a second reinforced (laminated) protective layer thereon by means of coating, spraying, adhering or other suitable manners, with similar or dissimilar materials to those of the second protective layer 20.

Still referring to FIGS. 4 and 5, by way of example, the second scratch-resistant layer 200 is formed from a single layer or multiple layers, with the second scratch-resistant layer 200 having a second predetermined thickness (thinner than that of second protective layer 20) about 0.1 mm to 5.0 mm and a second predetermined hardness (greater than that of second protective layer 20) to reinforce a degree of strength of the second protective layer 20 and to thereby minimize a thickness thereof in design, with a second minimized thickness of the second scratch-resistant layer 200 providing a degree of optical property to comply with international standards.

Still referring to FIGS. 4 and 5, by way of example, the thickness of first scratch-resistant layer 100 may be identical with or different from that of second scratch-resistant layer 200, with providing the first scratch-resistant layer 100 and the second scratch-resistant layer 200 to prevent occurrence of cracks. In a preferred embodiment, the hardness (i.e., sand or dust scratches in direction of facing wind blow side) of first scratch-resistant layer 100 may be identical with or different from that of second scratch-resistant layer 200.

Still referring to FIGS. 4 and 5, by way of example, the manufacturing method of composite high scratch-resistant optical lens device of the present invention further includes the step S3: forming at least one containing space layer 30 between the first inner surface 12 of first protective layer 10 and the second inner surface 22 of second protective layer 20 in a suitable manner, with providing a material of first protective layer 10 similar or dissimilar to that of second protective layer 20.

Still referring to FIGS. 4 and 5, by way of example, the manufacturing method of composite high scratch-resistant optical lens device of the present invention further includes the step S4: providing the intermediate layer 3 in the containing space layer 30 in a suitable manner for protecting the intermediate layer 3 between the first inner surface 12 of first protective layer 10 and the second inner surface 22 of second protective layer 20.

Still referring to FIGS. 4 and 5, by way of example, the intermediate layer 3 is selected from a 2D pattern layer, a 3D pattern layer, a microstructure pattern layer (e.g., polarization microstructure), a micro mechanism layer (e.g., micro electro mechanical system, MEMS or micro device) or combinations thereof.

Still referring to FIGS. 4 and 5, by way of example, the manufacturing method of composite high scratch-resistant optical lens device of the present invention includes the step S5: the first scratch-resistant layer 100 and the first protective layer 10 commonly protecting a first side of the containing space layer 30 while the second scratch-resistant layer 200 and the second protective layer 20 commonly protecting a second side of the containing space layer 30 to thereby extend a usage life of intermediate layer 3.

With continued reference to FIGS. 4 and 5, by way of example, in a preferred embodiment of the present invention, the intermediate layer 3 is integrated with the first inner surface 12 of the first protective layer 10 or the first scratch-resistant layer 100 is integrated with the first outer surface 11 of first protective layer 10 in a suitable manner (e.g., thermal treatment or other manners) by using similar optical materials therebetween to form a single layer.

With continued reference to FIGS. 4 and 5, by way of example, in another preferred embodiment of the present invention, the intermediate layer 3 is integrated with the second inner surface 22 of the second protective layer 20 or the second scratch-resistant layer 200 is integrated with the second outer surface 21 of the second protective layer 20 in a suitable manner (e.g., thermal treatment or other manners) by using similar optical materials therebetween to form another single layer.

With continued reference to FIGS. 4 and 5, by way of example, in another preferred embodiment of the present invention, the intermediate layer 3 is integrated with the first inner surface 12 of the first protective layer 10 and the second inner surface 22 of the second protective layer 20 or the first scratch-resistant layer 100 and the second scratch-resistant layer 200 are integrated with the first outer surface 11 of first protective layer 10 and the second outer surface 21 of the second protective layer 20 in a suitable manner (e.g., thermal treatment or other manners) by using similar optical materials therebetween to form a single layer.

FIG. 6 shows a schematic side view of a composite high scratch-resistant optical lens device in accordance with a second preferred embodiment of the present invention. Turning now to FIG. 6, by way of example, in comparison with the first embodiment, the composite high scratch-resistant optical lens device of the second preferred embodiment of the present invention includes a first protective layer 10, a second protective layer 20 and at least one intermediate layer 3, with integrating the intermediate layer 3 with the first protective layer 10 in a suitable manner to provide a single functional layer 3a, as best shown at upper portion in FIG. 6.

With continued reference to FIG. 6, the intermediate layer 3 is strengthened by incorporating a whole portion into the first inner surface 12 of first protective layer 10, with combining the second protective layer 20 with the single functional layer 3a of first protective layer 10 and intermediate layer 3 to form a composite double-sided high scratch-resistant optical lens device 1B.

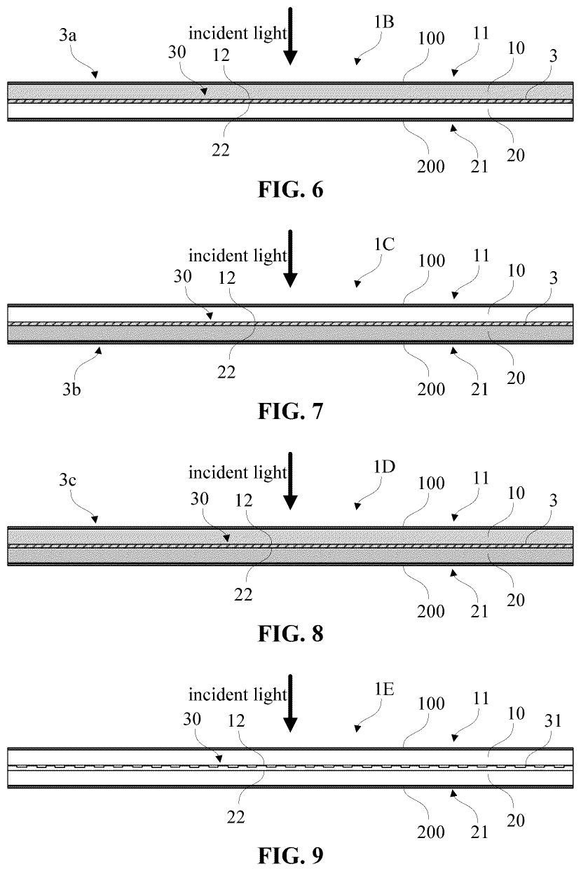

FIG. 7 shows a schematic side view of a composite high scratch-resistant optical lens device in accordance with a third preferred embodiment of the present invention. Turning now to FIG. 7, in comparison with the first embodiment, the composite high scratch-resistant optical lens device of the third preferred embodiment of the present invention includes a first protective layer 10, a second protective layer 20 and at least one intermediate layer 3, with integrating the intermediate layer 3 with the second protective layer 20 in a suitable manner to provide a single functional layer 3b, as best shown at lower portion in FIG. 7.

With continued reference to FIG. 7, the intermediate layer 3 is strengthened by incorporating a whole portion into the second inner surface 22 of second protective layer 20, with combining the first protective layer 10 with the single functional layer 3b of second protective layer 20 and intermediate layer 3 to form a composite double-sided high scratch-resistant optical lens device 1C.

FIG. 8 shows a schematic side view of a composite high scratch-resistant optical lens device in accordance with a fourth preferred embodiment of the present invention. Turning now to FIG. 8, in comparison with the first embodiment, the composite high scratch-resistant optical lens device of the fourth preferred embodiment of the present invention includes a first protective layer 10, a second protective layer 20 and at least one intermediate layer 3, with integrating the intermediate layer 3 with the first protective layer 10 and the second protective layer 20 in a suitable manner to provide a single functional layer 3c, as best shown at middle portion in FIG. 8.

With continued reference to FIG. 8, the intermediate layer 3 is strengthened by incorporating a whole portion into the first inner surface 12 of first protective layer 10 and the second inner surface 22 of second protective layer 20 to form a composite double-sided high scratch-resistant optical lens device 1D.

FIG. 9 is a schematic side view of a composite high scratch-resistant optical lens device in accordance with a fifth preferred embodiment of the present invention. Turning now to FIG. 9, in comparison with the first embodiment, the composite high scratch-resistant optical lens device of the fifth preferred embodiment of the present invention includes a first protective layer 10, a second protective layer 20 and at least one intermediate microstructure layer 31 which are combined to form a composite double-sided high scratch-resistant optical lens device 1E, as best shown at middle portion in FIG. 9.

With continued reference to FIG. 9, a pattern or a letter of the intermediate microstructure layer 31 is strengthened by incorporating a whole portion into the first inner surface 12 of first protective layer 10, the second inner surface 22 of second protective layer 20 or both.

Although the invention has been described in detail with reference to its presently preferred embodiment, it will be understood by one of ordinary skills in the art that various modifications can be made without departing from the spirit and the scope of the invention, as set forth in the appended claims.

What is claimed is:

1. An optical lens device comprising:
a first protective layer having a function of structural reinforcement;
a first scratch-resistant layer having a function of surface-scratch resistant, with providing the first scratch-resistant layer on a first outer surface of the first protective layer for forming a first reinforced protective layer thereon;
a second protective layer having a function of structural reinforcement;
a second scratch-resistant layer having a function of surface-scratch resistant, with providing the second scratch-resistant layer on a second outer surface of the second protective layer for forming a second reinforced protective layer thereon;
at least one containing space layer formed between a first inner surface of the first protective layer and a second inner surface of the second protective layer; and
at least one intermediate layer provided in the containing space layer for protection;
wherein the first scratch-resistant layer and the first protective layer are provided to commonly protect a first side of the containing space layer while the second scratch-resistant layer and the second protective layer are provided to commonly protect a second side of the containing space layer.

2. The optical lens device as defined in claim 1, wherein the intermediate layer is selected from an anti-reflection layer, a polarization thin-film layer, a polarization microstructure layer, a photochromic layer, an anti-blue layer, an anti-blue UV layer, an anti-infrared layer or combinations thereof.

3. The optical lens device as defined in claim 1, wherein the intermediate layer is integrated with the first inner surface of the first protective layer to form a single layer.

4. The optical lens device as defined in claim 1, wherein the intermediate layer is integrated with the first inner surface of the first protective layer while the first scratch-resistant layer is integrated with the first outer surface of first protective layer to form a single layer.

5. The optical lens device as defined in claim 1, wherein the intermediate layer is integrated with the second inner surface of the second protective layer to form a single layer.

6. The optical lens device as defined in claim 1, wherein the intermediate layer is integrated with the second inner surface of the second protective layer while the second scratch-resistant layer is integrated with the second outer surface of the second protective layer to form a single layer.

7. The optical lens device as defined in claim 1, wherein the intermediate layer is integrated with the first inner surface of the first protective layer and the second inner surface of the second protective layer to form a single layer.

8. The optical lens device as defined in claim 1, wherein the intermediate layer is integrated with the first inner surface of the first protective layer and the second inner surface of the second protective layer while the first scratch-resistant layer and the second scratch-resistant layer are integrated with the first outer surface of first protective layer and the second outer surface of the second protective layer to form a single layer.

9. The optical lens device as defined in claim 1, wherein the first protective layer has a first degree of hardness greater than a second degree of harness of the second protective layer.

10. The optical lens device as defined in claim 1, wherein the first protective layer has a first thickness greater than a second thickness of the second protective layer.

11. A manufacturing method for an optical lens device comprising:
providing a first scratch-resistant layer on a first outer surface of a first protective layer having a function of structural reinforcement to form a first reinforced protective layer thereon;
providing a second scratch-resistant layer on a second outer surface of a second protective layer having a function of structural reinforcement to form a second reinforced (laminated) protective layer thereon;
forming a containing space layer between a first inner surface of the first protective layer and a second inner surface of the second protective layer;
providing an intermediate layer in the containing space layer for protection; and
the first scratch-resistant layer and the first protective layer commonly protecting a first side of the containing space layer while the second scratch-resistant layer and the second protective layer commonly protecting a second side of the containing space layer.

12. The method as defined in claim 11, wherein the intermediate layer is selected from an anti-reflection layer, a polarization thin-film layer, a polarization microstructure layer, a photochromic layer, an anti-blue layer, an anti-blue UV layer, an anti-infrared layer or combinations thereof.

13. The method as defined in claim 11, wherein the intermediate layer is integrated with the first inner surface of the first protective layer by using similar optical materials therebetween to form a single layer.

14. The method as defined in claim 11, wherein the intermediate layer is integrated with the first inner surface of the first protective layer and the first scratch-resistant layer is further integrated with the first outer surface of first protective layer, with using similar optical materials therebetween to form a single layer.

15. The method as defined in claim 11, wherein the intermediate layer is integrated with the second inner surface of the second protective layer by using similar optical materials therebetween to form a single layer.

16. The method as defined in claim 11, wherein the intermediate layer is integrated with the second inner surface of the second protective layer and the second scratch-resistant layer is further integrated with the second outer surface of the second protective layer, with using similar optical materials therebetween to form a single layer.

17. The method as defined in claim 11, wherein the intermediate layer is integrated with the first inner surface of the first protective layer and the second inner surface of the second protective layer by using similar optical materials therebetween to form a single layer.

18. The method as defined in claim 11, wherein the intermediate layer is integrated with the first inner surface of the first protective layer and the second inner surface of the second protective layer and the first scratch-resistant layer and the second scratch-resistant layer are further integrated with the first outer surface of first protective layer and the second outer surface of the second protective layer, with using similar optical materials therebetween to form a single layer.
